(19) United States
(12) Patent Application Publication
(10) Pub. No.: US 2025/0282663 A1
(43) Pub. Date: Sep. 11, 2025

(54) SYSTEM AND METHOD FOR ANAEROBIC WASTEWATER TREATMENT

(71) Applicant: NEWhub Holding Company, Herndon, VA (US)

(72) Inventors: Eugenio Giraldo, Robbinsville, NJ (US); Bernhard Wett, Innsbruck (AT); Sudhir Murthy, Herndon, VA (US); Charles Bott, Virginia Beach, VA (US)

(21) Appl. No.: 19/053,635

(22) Filed: Feb. 14, 2025

Related U.S. Application Data
(60) Provisional application No. 63/553,457, filed on Feb. 14, 2024.

(51) Int. Cl. C02F 11/04

(52) U.S. Cl. CPC C02F 11/04; C02F 2203/004; C02F 2203/006

(57) ABSTRACT

Systems and methods for enhancing the capacity, treatment, or purifying gas of an anaerobic bioreactor used for wastewater treatment are presented. The limitations associated to the retention of granular sludge are overcome by providing a densified aggregate selector that is used to return the granules back to the bioreactor when washed away with the effluent or by selectively wasting flocculent sludge from the contents of the bioreactor furthering the retention of granular sludge. Means of further enhancing granule retention using a support, the granules separator and an auxiliary bioreactor are presented.

### RELATED APPLICATIONS

This regular utility non-provisional patent application claims priority benefit with regard to all common subject matter of U.S. Provisional Patent Application Ser. No. 63/553,457, filed Feb. 14, 2024, entitled “SYSTEM AND METHOD FOR ENHANCED WASTEWATER TREATMENT USING SCREENS ANC CYCLONIC DEVICES”. The above-identified patent application is hereby incorporated by reference in their entirety into the present patent application.

### BACKGROUND

Anaerobic bioreactors are widely used in wastewater treatment as a means of removing carbonaceous compounds from wastewater by converting them to biogas. Numerous anaerobic bioreactors exist in practice such as, but not limited to, Upflow Anaerobic Sludge Blanket UASB, bioreactors, Internal Clarifier (IC) Reactors, Enhanced Granular Sludge Bed, EGSB, or Anaerobic Contact Process bioreactors which rely on the formation of highly active microbial aggregates with good settling characteristics. Influent wastewater is put in contact with these anaerobic granules, within the bioreactor promoting the formation of methane and carbon dioxide from the carbonaceous compounds in the wastewater. Carbon dioxide and methane being both carbonaceous gases escape from the wastewater forming an excess gas called biogas and effectively removing said carbonaceous compounds from the wastewater. Biogas might also contain trace amounts of other gases such as hydrogen sulfide, hydrogen, carbon dioxide, ammonia and other trace volatile gases. In some applications flocculent sludge is also present within the anaerobic bioreactor. Flocculent sludge is not as desirable as granules because it does not settle as well, and the methanogenic activity, the amount of biogas produced per unit of biological solids, is lower than granules reducing the volumetric processing capacity of the reactor.

The wastewater depleted of carbonaceous compounds is considered treated wastewater and becomes an effluent to the anaerobic bioreactor. The reactors provide a way of separating the liquid wastewater, from the biogas and sludge when present, retaining the sludge within the bioreactor and removing the treated effluent and the biogas; in some anaerobic bioreactors the separation of the sludge from the liquid occurs in specialized solid liquid gas separation structures within the bioreactor, while yet in other cases an external structure to the bioreactor is provided to retain the sludge when present and to return them to the bioreactor as is the case of the anaerobic contact process or membrane bioreactors, but others exist. In some anaerobic bioreactors a support media is introduced to induce biofilm growth in said media to enhance the settleability and the ability to separate the biofilm coated media from the two fluids, liquid and gas. An example, as there are others, of said bioreactors with biofilm coated media is the anaerobic fluidized bed or anaerobic attached film expanded bed bioreactors, AAFEB.

Yet in other cases anaerobic bioreactors are used where mostly flocculent sludge with relative low methanogenic activity is formed and separation of sludge from the treated wastewater occurs via a membrane, typically a microfiltration or ultrafiltration membrane. Formation of granules is advantageous because granules increase the flux through the membrane and enhance the volumetric capacity of the membrane bioreactor. Many of these reactors induce granulation by providing verticality with an internal separator at the top using shear forces and from a feed from bottom approach where heavier or larger granules preferentially receive substrates at the bottom. These reactors while superior in footprint are mechanically complex and expensive to construct within a hydraulic flow of a plant or within existing infrastructure. For example, the minimum height of current art anaerobic reactors relying on internal separator is 15 feet; the present invention enables use of shallower bioreactors with less than 15 feet height, or enhance the capacity of existing anaerobic bioreactors with more than 15 ft height. Yet in other applications existing tanks not originally designed as anaerobic bioreactors can be repurposed as anaerobic bioreactors with granules, such as repurposing primary clarifiers or even sewer systems.

The present invention induces the formation of granules in anaerobic systems, including a membrane bioreactor or a reactor of low verticality, or a reactor approach that primarily consists of flocculant sludge, or even within an anaerobic sewer network (by its conversion to a bioreactor) by selectively wasting flocculent sludge and retaining granules in the system. In one embodiment, a mix of flocs and granules are produced to manage substrate diffusion, differential settling of biological active aggregates and selective wasting of slow and rapid growth organisms.

Some anaerobic bioreactors are used to ferment soluble organic matter forming mixed fermentation products such as volatile fatty acids, VFA, namely, acetic, propionic, butyric, lactic and others, with limited amounts of biogas, mostly carbon dioxide, some hydrogen and limited amounts methane. These reactors are usually called acidogenic reactors and formation of granules or biofilm coated media is also advantageous for the process. In these proposed bioreactors introduction of small amounts of oxygen, microaeration, is considered advantageous to the hydrolysis and fermentation reactions. The introduction of microaeration can induce losses of granules or biofilm from the bioreactor limiting its capacity. The organisms that are facilitated by microaeration can speed up fermentation reactions of particulate substrates. If these are fast growing organisms, they could therefore reside in flocs that are not coupled to granules thus allowing for them to be preferentially wasted.

In some systems, it may be desirable to convert much of the generated CO2 into methane using hydrogen as a substrate. This biomethanization may be desirable to provide enriched methane within pipelines to urban centers. This biomethanization of produced CO2 is envisioned in this invention by enriching the required organism within the biota.

The separation of the three fractions, liquid, gas, and biological solids, flocculent sludge and granules can become the limiting step in the treatment capacity of a bioreactor. When the separation is not efficient granules are not fully retained within the bioreactor and wasted away with the effluent wastewater. Waste of granules limits the amount of active biomass within the bioreactor and consequently limits the capacity to convey the conversion of carbonaceous matter in the influent wastewater to biogas. Several different mechanisms can be attributed to the loss of granules in the effluent but all of them end with an impact on the volumetric capacity of the bioreactor to treat wastewater influent.

### SUMMARY

The present invention uses a physical selector, such as a density, size or shear selector and presents a way of enhancing the capacity of anaerobic bioreactors to conduct their optimized biogasification and mineralization of carbonaceous or sulfur containing compounds in the influent wastewater by providing means of enhancing retention of the active biomass, granules or densified aggregates/biomass, in the bioreactor. In some instances, the selector is used for enhanced retention by collecting the aggregates/granules that are carried away from the bioreactor with the effluent and returning them to the bioreactor, in other instances selective removal of lower methanogenic activity flocculent sludge with selective retention of aggregates/granules is conducted. The optimized retention by the selector of the appropriate particulates (including substrates), aggregates/granules and flocs under partial or full anaerobic/methane generating condition is the subject of the invention, For the purposes of this invention a granulation is differentiated from densification, where the densification relies upon the preferential retention of fraction of organisms and substrates using size or density separation using a physical separator, selector, such as a screen or a hydrocyclone, or a differential settling device. The aggregate of such dense and light active biomass from an anaerobic bioreactor that treats wastewater by converting carbonaceous compounds to biogas where the overall biomass is optimized from an activity perspective. Densification is differentiated from granulation, where in the context of granulation, mostly granular mass is desired, while in densification, we desire the optimized approach for light and heavy aggregates that have distinct diffusion gradients that facilitate the breakup of substrates but in niches of organism groups within morphologies. Selective retention and wasting in the selector enables control of the flocculent and granular components. This densified biomass could typically get washed out under high hydraulic (overflow, upflow, or downflow) rates, but for their high settling rates that allow for their retention. On the other hand the appropriate amount of light fraction flocs are retained, while the remainder is purposefully washed out, for preferential conversion of residual substrates under low substrate gradients for a high quality effluent. A desired densification can have between 10 and 90% densified aggregates and between 90 and 10% lighter aggregates depending on the desired microbial functionality in these aggregates. The densified aggregates themselves can be further classified to various spectrum of size fractions to support different organisms (herein referred to a mixed spectrum aggregates). One selector can be composed of individual separation units in series or in parallel that classify the spectrum of aggregates by size and/or density enabling further control of the fractions retained and wasted.

In an example embodiment elucidating the mixed spectrum, acidogenic heavy aggregates/granules are active biomass that conduct fermentation of organic matter to VFA and limited amounts of biogas, mostly carbon dioxide, some hydrogen and some methane and traces of other gases. In some cases, the acidogenic organisms can exist on lighter aggregates or on the heavy aggregates, or in an ‘in between’ size or density of aggregate mixed spectrum for optimized degradation of readily biodegradable chemical oxygen demand (COD) to VFA. An embodiment goal is to provide such opportunities for mixed spectrum aggregates (the proverbial horses for courses approach), where an aggregate is both sufficiently retained and has sufficient diffusion mass transfer resistance for the desired organism profile (in this case acidogens).

In some instances, these granules are biologically active aggregates with no apparent support-media, such as but not limited to sand (including grit material naturally present in influent wastewater), or plastic, while in other cases the aggregates are part of a combined support-media biological active biomass growing as a biofilm on the media. For the purposes of this invention support media is a media that provides means for growing anaerobic microorganism attached to said media. The media can be of a large variety of materials such as but not limited to sand or silicic, plastic (including biodegradable plastics), activated carbon, biochar, chitin, lignocellulosic materials, biopolymers, and/or composite materials from one or more sources that enhance anaerobic microbial growth and creation of an active biofilm. These media based materials could be retained at higher solids residence times, SRTs, than self-agglutinating heavy aggregates, which in turn are retained at higher SRTs than lighter aggregates, thus generating a multitude or a mixed spectrum of SRTs for fast or slow growing organisms, or for low or high diffusion conditions to include such media or migrating carriers.

In an embodiment describing microaeration and organism morphology and function: organisms growing at high rates or preferring low diffusion conditions such as from microaeration would reside in the smaller sized particles (they are not susceptible to be washed out). Whilst, slower growing organisms or organisms receiving sufficient substrates, would be able to reside in the depths of a granule (and away from the induced microaeration). Slow growing organisms would be retained on larger or denser particles relative to the faster growing organisms grown on flocculent sludge. The microaeration in an embodiment is targeted at flocculant sludge to improve hydrolytic activity to breakdown macromolecule or particulate substrates or in another embodiment microaeration is targeted to convert sulfides to elemental sulfur.

Higher rate functionality is preferentially committed to the flocculant morphology in another embodiment and subject to a more rapid wasting protocol, including for example anoxic reactions.

In an embodiment describing media use, media can be used to target organisms that are even slower growing or if the media is reactive, it could be fashioned into a counter-diffusion support containing nutrients or catalytic agents to grow or promote a specialist organism (such as for micropollutant degradation). The media could also be hydrophilic or charged, Some types of micropollutants are in an oxidized state (such as many halogenated compounds) and could benefit from anaerobic action to cleave off the most hazardous moiety, and the depolluting organisms could reside either in granules or media (inert or reactive) where their slow growth is supported through longer residence time (high SRT) in the bioreactor. Yet in an alternative embodiment describing reactive media use, media can be coated with nucleation crystals for precipitate formation and when media is introduced in the bioreactor where crystals are formed-such as crystals of iron compounds or calcium compounds or magnesium compounds, namely brushite, struvite, vivianite, or others, will nucleate on the added coated media and grow around it. The media is then separated in the selector and recycled or collected for use through a discharge mechanism.

In an embodiment describing use of chemical agents, an oxidant (such as ozone) or a reductant (such as hydrogen or an electron source/beam) can be added to facilitate the catalysis or degradation of substrates or micropollutants in a single or mixed redox condition. This oxidant or reductant can be added in an embodiment with a submersible pump or a pump immediately ahead of a selector, or alternatively inside of the high shear environment of a shear selector, that can disperse the oxidant or reductant near instantaneously within the pump or selector itself, to provide the needed radicals or catalysis for breakdown of chemicals for subsequent biological action in the reactor. These media could be separated and subject to various oxidative or reductive chemistries to promote their activity as aforementioned. Reactive media also includes media that has active ion exchange moieties enabling preferential sorption of ionic water species, or media with very high surface area that promotes sorption of hydrophobic molecules, or media that is electrically conductive to enhance electrotrophic organism activity, or facilitates electron transport between organisms.

In an aspect, the present invention provides a method for enhancing the treatment capacity of an anaerobic bioreactor used for wastewater treatment. In an embodiment, the first step of the method is collecting the effluent from the anaerobic bioreactor. The second step of the method is passing the effluent through a densified aggregate selector to form a fraction containing granules and a treated effluent. The third step of the method is returning at least a portion of the fraction containing one or more granules to the bioreactor. The fourth step of the method is optionally adding a stream of support media to the bioreactor.

In an embodiment, where at least a portion of the fraction containing one or more granules is first returned to an auxiliary bioreactor prior to returning to the anaerobic bioreactor. The auxiliary bioreactor has a mixed liquor exchange with the anaerobic bioreactor. The auxiliary bioreactor is operated under anaerobic conditions producing a stream of biogas. A stream of oxygen is optionally supplied to the auxiliary bioreactor. The auxiliary bioreactor receives at least a portion of the influent flow or sends at least a portion of its effluent flow to biological nutrient removal. The auxiliary bioreactor receives at least a portion of the influent flow. The optional structure media is a reactive media.

In another aspect, the present invention provides a method for enhancing the treatment capacity of an anaerobic bioreactor used for wastewater treatment by selectively removing flocculent sludge from the bioreactor. In an embodiment, the first step of the method is collecting a portion of the contents of said anaerobic bioreactor. The second step of the method is passing said portion of the contents through a densified aggregate selector to form a fraction containing granules and a fraction containing flocculent sludge. The third step of the method is returning at least a portion of the fraction containing granules to the bioreactor. The fourth step of the method is removing the fraction containing flocculent sludge. The fifth step of the method is optionally adding a stream of support media to the bioreactor.

In an embodiment, the anaerobic bioreactor is an acidogenic bioreactor. The oxygen is introduced to the acidogenic bioreactor to enhance hydrolysis reactions. The anaerobic bioreactor is a membrane bioreactor. At least a portion of the fraction containing granules is first returned to an auxiliary bioreactor prior to returning to the anaerobic bioreactor. The auxiliary bioreactor receives at least a portion of the influent flow or sends at least a portion of its effluent flow to biological nutrient removal. The hydrogen gas is added to the auxiliary bioreactor to further methane production and methane enrichment in biogas.

In another aspect, the present invention provides a system for enhancing the treatment capacity of an anaerobic bioreactor used for wastewater treatment comprising: an influent source to the bioreactor, an optional source of support media, an anaerobic bioreactor, a densified aggregate selector, an optional auxiliary bioreactor, an optional source of oxygen, and pipes, valves, and pumps to fluidly connect the above-mentioned parts of the system. The system is arranged in ways that the influent source to the bioreactor is fluidly connected to said anaerobic bioreactor. The bioreactor has means of optionally receiving support media from the source. The bioreactor is fluidly connected to the inlet of the densified aggregate selector, and one of the outlets of the densified aggregate selector is fluidly connected to the anaerobic bioreactor.

In an embodiment, an auxiliary bioreactor is fluidly connected to the outlet of the densified aggregate selector containing the separated granules, and fluidly connected to the anaerobic bioreactor, and has an optional fluid connection to the influent flow, and an optional connection to a nutrient removal bioreactor. The anaerobic bioreactor and the auxiliary bioreactor fluid connections are configured to allow a mixed liquor exchange between the two bioreactors. In the system, means of supplying a stream of oxygen to the auxiliary or to the anaerobic bioreactor are provided. The anaerobic bioreactor is a membrane bioreactor. The support media is reactive media.

Yet in other embodiment a control system for addition of elutriation influent to an acidogenic bioreactor is utilized. Control is based on a set point for pH. The control system actuates on the flow or elutriation water to maintain the pH around a set point or withing a band of set points. The set points can be selected between 4 and 6 pH units.

### BRIEF DESCRIPTION OF THE DRAWING FIGURES

Embodiments of the present invention are described in detail below with reference to the attached drawing figures, wherein:

FIG. 1 is a schematic diagram of a selector illustrating one influent stream and multiple effluent streams.

FIG. 2 is a schematic diagram of an enhanced wastewater treatment system constructed in accordance with an embodiment of the present invention.

FIG. 3A is a schematic diagram of an enhanced wastewater treatment system constructed in accordance with an alternative embodiment of the present invention incorporating an auxiliary bioreactor that receives returned granules and puts those in contact with the influent.

FIG. 3B is a schematic diagram of an enhanced wastewater treatment system constructed in accordance with an alternative embodiment of the present invention incorporating an auxiliary bioreactor with active mixed liquor exchange with the main anaerobic bioreactor.

FIG. 4 is a schematic diagram of an enhanced wastewater treatment system constructed in accordance with an alternative embodiment of the present invention incorporating mixed liquor exchange to the densified aggregate selector and an auxiliary bioreactor.

FIG. 5 is schematic diagram of an enhanced wastewater treatment system constructed in accordance with an alternative embodiment of the present invention incorporating mixed liquor exchange to the densified aggregate selector and an auxiliary bioreactor.

FIG. 6A & FIG. 6B illustrate the reduction to practice of one embodiment of a selector of the present invention where a microscreen installation in an anaerobic tank is depicted.

FIG. 7A and 7B illustrate the reduction to practice of an embodiment of a selector of the present invention with an external sieve receiving a stream of anaerobic reactor contents, granule separation and pass-through fraction.

FIG. 8 illustrates results from an installation of a screen on the evolution over time of the size of granules and flocs in an anaerobic reactor using the system of this invention.

FIG. 9 is a schematic diagram of an enhanced wastewater treatment system constructed in accordance with an embodiment of the present invention.

FIG. 10 is a schematic diagram of an enhanced wastewater treatment system constructed in accordance with another embodiment of the present invention.

### DETAILED DESCRIPTION

Anaerobic treatment consists of a broad range of processes including the aforementioned use of a reactor (USAB, EGSB, IC, etc.) or a digester (such as anaerobic sludge digestion). A problem with anaerobic treatment or digestion is that it's a slow process and there is a desire to uncouple the SRT, especially to accommodate slow growing organisms and to effectively separate out these organisms. This is where the use of selectors, i.e. size selector, density selector or shear selector becomes important, and where the selector is typically used to retain the heavier, larger or shear resistant fraction and to deselect the lighter, smaller or less shear resistant fractions for treatment or digestion. The shear selector can also engineer porous and exposed morphologies, from such shearing, within either the sheared or the shear resistant fractions. There are many such selectors but our preferred use of screens and hydrocyclones either separately or jointly or in combination with lamellas or plates or vacuum, or in combination with chemical introduction, is foreseen in this invention. The hydrocyclones can be operated at any flow rate from as low as 5 m3/h to as high as 50 m3/h or greater and at a pressure of as low as 10 psi to as high as 100 psi. The hydrocyclone underflow returns the heavier fraction to the bioreactor and wastes the lighter fraction. In the context of mineral separation, a heavier fraction could be extracted as a discharge. The screens (or filter) are often microscreens in a size range of 50 to 2000 microns but in some cases it is as high as 5000 microns or even 10000 microns but certainly smaller than that used to retain large plastic media such as for moving bed biofilm reactors or integrated fixed film reactors. The fraction retained (some or all) on these screens are returned and fraction that passes through (some or all) is wasted. In the context of mineral separation, a larger fraction may be extracted as a discharge. These selectors (such as screens, hydrocyclones, lamella or dissolved gas floatation) are classifiers and not solid-liquid-gas separators, and can be located inside the reactor (within the headspace or within the fluid) or external to the reactor (for treatment or digestion). Internal structures on current art are solid-liquid-gas separators, three phasic, to collect gas and create a quiescent settling space for granules where gas turbulence is avoided and granules are separated from the liquid by gravitational settling, returned to the bioreactor active zone and the liquid passes through as effluent; internal selectors in one embodiment, are not three-phasic structures, and only separate granules from the other two phases, namely gas and liquid. The role of the selector in one embodiment is to produce or sculpt the desired morphology and/or to classify. The classification can be between aggregates of various sizes, density or shear characteristics. In one embodiment, where a screen is placed in the effluent, the fraction retained may be wasted in larger quantities only if there is sufficient dense or large aggregates already present in the bioreactor. In one embodiment, if the fraction retained consists of large quantities of grit, this material can be degritted and removed from the underflow either in a single or multiple (series or parallel) selection steps using a selector specially configured for such high density particles. If there are floatables, a pre-screen may be used to remove them first (in the retained fraction) before selection of the biomass is performed. The primary objective, however, is to uncouple the SRT of retained and wasted fraction of biomass containing self-agglutinating or media supported particles, where the retained fraction have slower growing organisms relative to the waste.

In one embodiment, a separator (such as a clarifier, lamella, plate, pipe, or dissolved gas floatation) is used for solid-liquid separation and this separator is distinct from a selector. In one embodiment, the two (separator and selector) can be combined, especially when the combination is used in the effluent of the reactor (in lieu of the waste stream).

For the purposes of this invention, the term densified aggregate is used to describe aggregates selected using either one or more of a size, density or shear selector (such as a screen, hydrocyclone, centrifuge, dissolved gas floatation or lamella, or differential settling separators based on mixing control or intermittent mixing), where a mix of aggregates of different SRTs are selected using a classification process. The selection is also associated with concomitant deselection, where aggregates are wasted based on size, density or shear. The term densification is linked to densified aggregates, and refers to the decoupling of SRT and combining this decoupling with physical selection based on any force such as compression, shear, gravity/density, floatation that occurs either on the solids directly obtained from the reactor or a concentrated source of solids that has been clarified.

In one embodiment, especially for using a dissolved gas floatation selector, the lighter and less dense supernate fraction (or more porous fraction) is selected and retained, although the opposite may occur as well.

There are many reactions that can occur in the anaerobic treatment reactor. The reactions often start with the breakdown of macromolecular substrate in the form of large particles to smaller particles and to soluble substrate. This breakdown can be achieved physically (using mechanical or hydraulic devices) or chemically (such as using low or high pH or using an oxidant (including ozone or microaeration) or reductant (including electron source or hydrogen)) or biologically (such as using enzymes that are in the extracellular milieu). This physical or chemical breakdown or enzymatic activation can be achieved in the selector such as with physical shear or with the introduction of a chemical in a shear device, or the by enhancing the surface area of the aggregates for biological action. This hydrolytic breakdown in one embodiment is facilitated by the exposure of surface area for such action either of the substrate or in the aggregate or both. The breakdown of large macromolecules is often the rate limiting step and this enhancement is an embodiment of this invention. The use of selectors to expose and/or breakdown macromolecule or to retain macromolecules (for a longer SRT) is one feature of the invention. Furthermore, the use of selectors to create more porous structures is also another feature. The use of selectors to retain organisms that conduct such breakdown (using enzymes) is another feature. The physical or chemical augmentation using a pump or in the selector itself for such breakdown is another feature. All of these features are introduced in the apparatus (or system apparatus when inclusive of the selector and bioreactor) or conducted as a method. The macromolecules can be colloidal in size and can be large chunks of 10,000 microns or greater size. It should be noted that these macromolecular presence and their inability to breakdown can lead to failure of granulation in these anaerobic reactors and the ability to prevent such failure by promoting their breakdown is an inventive feature.

Once these macromolecules are solubilized, the soluble constituents are likely subject to acidogenesis (i.e. production of volatile fatty acids or VFA). Microaeration or chemical addition can facilitate acidogenesis or to manage the pH or redox conditions to improve acidogenesis yields and rates. Elutriation, using a diluent or using the flow of influent itself or by management of pH (such as using an alkali) can be used to improve such acidification. A control algorithm using pH or redox is an inventive feature. This acidification step (acidogenesis and/or acetogenesis) may be an intermediate step to send the carbon produces to a downstream process for denitrification or biological phosphorus removal, especially if the solids are adequately separated) or if the VFA is subject to vacuum removal. The separation of VFA (via elutriation or vacuum) in combination with a size, density or shear selector is a feature of this invention. This separation can occur using the selector or in a different solid-liquid (such as a lamella, clarifier, thickener or dewatering) or gas-liquid (such as vacuum) separator device. In one embodiment, the vacuum is applied in combination with the selection step. Ammonification may occur and the removal of ammonia in a similar fashion is envisioned.

In one embodiment, gas purification (to produce methane) occurs by one or more of adding hydrogen to convert carbondioxide to methane or by adding microaeration to convert hydrogen sulfide to elemental sulfur, or adding chemicals or operations in a manner to remove other impurities.

There are various forms of methanogenesis envisioned including and not limited to acetoclastic methanogenesis where the substrate molecule is most often acetate, hydrogenotrophic methanogenesis that uses hydrogen or formate to reduce carbon dioxide, methyl-based methanogenesis that includes methyl dismutation and methyl reduction or methoxy dotrophic methanogenesis that involves demethoxylating aromatic compounds. Any of these inclusive forms of methanogenesis and the organisms involved can be subject to selection (within the dense., large or shear resistant aggregates).

In one embodiment, hydrogen is introduced, either as a reductant or a substrate, and wherein in another embodiment, the hydrogen is sourced from electrolysis of water, and wherein the hydrogen is used for biomethanization. The hydrogen is optionally dispersed or sparged into the influent or bioreactor in an efficient manner to convert CO2 efficiently to methane. This reaction is facilitated using the selector where in an embodiment, the shear in the selector is used to micronize hydrogen to maximize surface area. The hydrogen (optionally sufficiently pressurized) in one embodiment is sucked into a pump without the need for a compressor, microbubbles are generated (using centrifugal, friction and/or axial forces) within the fluid being pumped to the bioreactor, thus sucking, mixing and dissolving the hydrogen in a single unit. This hydrogen is used to convert almost all the CO2 produced in the reactor from heterotrophs and other methanogens to methane. As a result, the methane fraction is increased in the bioreactor to optionally increase its purity for subsequent introduction into pipelines. These organisms are grown in the bioreactor within morphologies retained within selectors.

In one embodiment, aged organisms (longer SRT) are sheared to provide the required surface area and porosity within the sheared and smaller, less dense and sheared aggregates for improved enzymatic, hydrolytic or treatment function. Here the selector functions to regulate the aggregates including the formation as well as the subsequent “shear off or breakdown” of the longer SRT aggregates that have the desired functionality. This feature is novel and a feature of this invention. In one embodiment, media (such as inerts, grit or other materials) can increase such shearing.

Two anoxic reactions commonly found under anaerobic conditions are sulfate reduction and iron reduction (ferric to ferrous). Both these reactions are envisioned. These reactions are much faster than the methane generating reactions and the organisms may be selected for shorter SRTs within the treatment or digestion process/reactor.

Acetate oxidation to hydrogen is a slow growing organism that can be selected within the treatment or digester. These organisms are often anaerobic clostridia, and can be nitrogen fixers under certain conditions, and this reaction or organism or feature may be selected for within the invention.

The solid liquid selector can be a gravity separator (including lamella or plate separator), a dissolved gas floatation (including associated with the aforementioned gas mixing pump), or a lift device.

One embodiment consists of an auxiliary reactor that is used in addition to the main bioreactor as a separate reactor or as a stage or zone within the main reactor. The purpose of this reactor is to improve reaction rates (including hydrolysis or particle breakdown, or bimethanization using hydrogen), or to provide conditions for biological/metabolic selection of large aggregates. The auxiliary reactor can be upstream of the bioreactor to provide stratification or substrate gradients, or for providing a zone for improving hydrolysis of material including using returned aggregates selected (the denser, larger or shear resistant aggregates) or deselected (lighter, smaller, sheared off and porous) from a selector. The auxiliary reactor can be downstream, a distributary or tributary to the main reactor.

A granule separator is a form of densified aggregate selector, wherein the granule separator is a classifier of granules for selection from flocs. The same selection equipment are used.

In one embodiment, the reactor or process can be of any shape and can include a sewer, primary, UASB, thickener or any reactor. The sewer can be gravity, pumped or under a vacuum. The sewer can have a recycle stream as needed, and it could be bioaugmented with methanogens from a septic system or systems and have numerous influent sources.

In one embodiment, a vacuum, negative or positive pressure source can be used if needed for fluid or gas management or evacuation.

In one embodiment, the anaerobic reactor or process is suited for shallow tanks of 20 feet depth or lower.

There are multiple approaches and combination of approaches and blend of approaches associated with the below described drawings and any combinations amongst the drawings are possible and should not necessarily be looked upon in isolation.

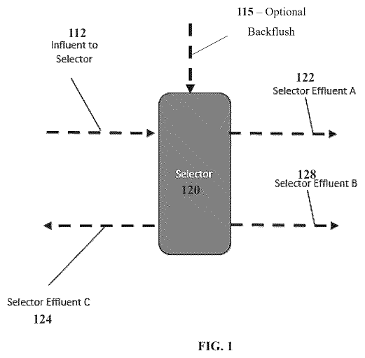

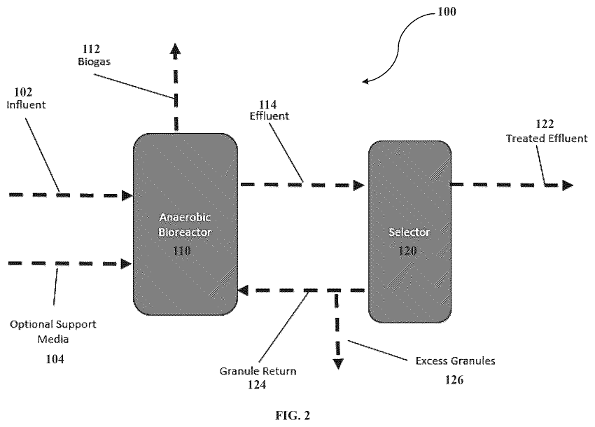

A schematic of a selector is presented in FIG. 1. A fluid influent 112 to the selector 120 is a stream from the anaerobic reactor/process 110 having at least one aggregate that is selectively retained or deselectively allowed to pass through forming at least two effluent streams referred to effluent A 122, effluent B 128 and effluent C 124. A selector 120 can have more than two effluent streams as when several selectors are arranged in series or in parallel or in a tributary or distributary. This enables classification of the contents of the influent 112 stream in multiple effluent streams and optionally returning at least one portion of those separated streams back to the process or to preferentially remove, waste, those streams from the system. The selector 120 could be based on differential settling devices such as upflow clarifiers, lamella clarifiers, hydrocyclones, or centrifuges, or intermittent mixing devices, or floatation devices or any device where settling differential velocity is the mechanism used for separation of streams. The selector 120 could also be based on sieving, like screens, or membranes, or paper filters, or cloth filters, or straw filters, or any other device where size, compressibility or shear resistance is used for separation. Yet in other embodiments the selector 120 could also be based on electromechanical separation of the influent 112 stream such as magnets. And further yet the selector 120 can be a plurality of individual selectors working in series or in parallel to produce more than one effluent stream. The selector 120 can be located external to the bioreactor or internal to the bioreactor. Internal structures on anaerobic reactors in current art are solid-liquid-gas separators, three phasic, to collect gas and create a quiescent settling space for granules where gas turbulence is avoided and granules are separated from the liquid by gravitational settling, returned to the bioreactor active zone and the liquid passes through as effluent; internal selectors in the present invention are not three-phasic structures only separate granules from the other two phases, namely gas and liquid and serve as classifiers of different agglomerate sizes for wasting or retaining to induce selective pressure on microorganisms growing in the different fractional sizes.

FIG. 2 is a schematic diagram of an enhanced wastewater treatment system 100 constructed in accordance with an embodiment of the present invention. In one embodiment an anaerobic bioreactor 110 receives influent 102 wastewater with carbonaceous, sulfurous or halogenated compounds or bubbled hydrogen gas, where at least a fraction is biogasified to form biogas 112, said biogas 112 is separated from the liquid effectively removing some of the carbonaceous, sulfurous or halogenated compounds or bubbled hydrogen gas from the influent 102 wastewater (or augmented separately) and forming an effluent 114 wastewater. The biogasification is carried out using densification by a mixture of flocculent sludge (lighter aggregates) and granules (or densified aggregates) inside the bioreactor 110 and at least a fraction of said granules exits the, bioreactor with the effluent 114. In some embodiments the bioreactor 110 receives support media 104 (or uses inerts in the influent) to effectively enhance the formation of granules or otherwise support biofilms, while in other embodiments no support media is added, and the granules are formed with no apparent support (self-agglutinating). The effluent is conveyed to a densified aggregate selector 120 where a fraction of the granules is separated 124 from the effluent 114 and returned to the bioreactor 110. In some embodiments some of the granules separated from the effluent are wasted as excess granules 126 and treated effluent 122 while in other embodiments no wasting is conducted at this step. For the purpose of this invention a granule or densified aggregate or biofilm media selector 120 (collectively called densified aggregate selectordensified aggregate selector 120) could be: a) a screen or any similar device (including but not limited to a filter mesh or fabric) where granules, self-agglutinating granules or support media induced granules, are retained by sieving the liquid and particles are separated based on factors such as size, compressibility, shape, magneticity or density. A multitude of different types of sieving equipment exists (including stationary, vibrating, rotating or moving) with associated wash equipment (air or fluid wash) in wastewater practice where granules can be separated from wastewater and that would be consider feasible for someone skilled in the art; b) a density-based or cyclonic (including but not limited to hydrocyclones, centrifuges, or a classifier) device, such as but not limited to a hydrocyclone, or a vortex separator where rotational flow is generated in the liquid in the device to induce a centrifugal force that is used to effectively separate the densified aggregates from the liquid based on granule characteristics such as size, shape and density.

Yet in some embodiments the densified aggregate selector 120 is incorporated as one unit internal to the bioreactor 110 while in other embodiments the densified aggregate selector 120 unit is an external unit to the bioreactor 120. These screens (separating mainly based on particle size) or cyclonic separators could be individually used, be combined into a single unit, or be placed in series if so desired. Inerts could be removed (such as by sludge or wastewater degritting) before or after this granule/densified aggregate separation to have a holistic approach to managing and improving active inventories in the anaerobic bioreactor). Similarly, fats, oils and grease (FOG) or scum (including floatables) could be managed (such as through floatation or screening, especially if they are less dense or form globules) in this holistic inventory management approach within such separations, either in series or parallel to the densified aggregate selector. In one example embodiment, large floatables are removed (and wasted) before smaller granules are retained. Any parallel, series, tributary or distributary approach is possible for such solids management.

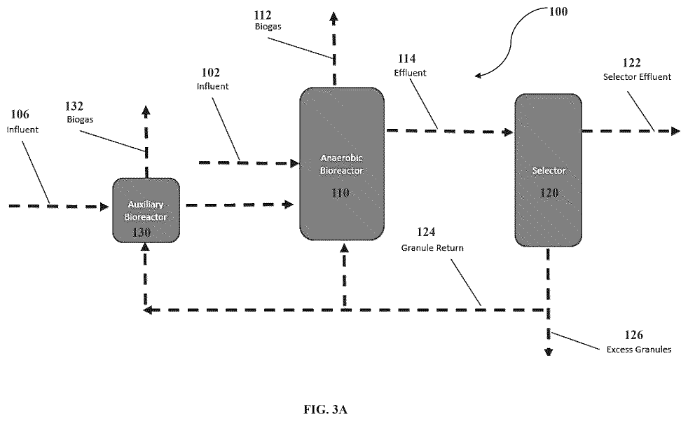

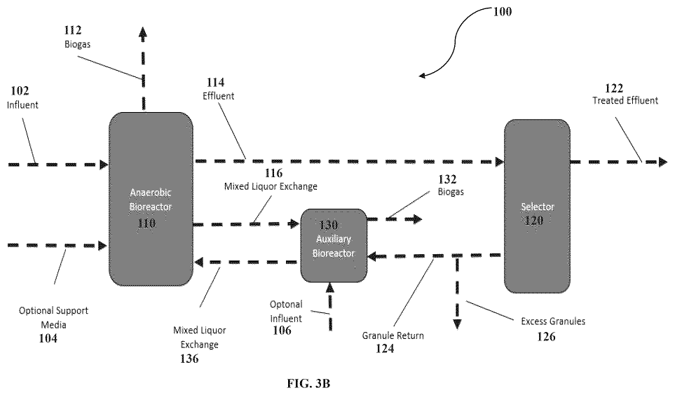

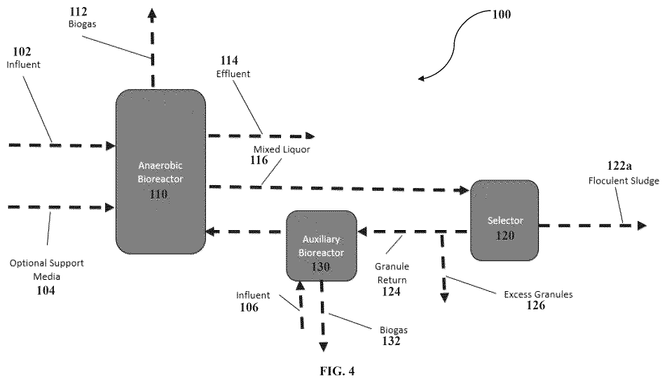

The densified aggregate selector 120 (s) could be internal to the bioreactor 110, external to the bioreactor 110, in the sludge or effluent streams or linked to the auxiliary bioreactor 130. FIGS. 3A & 3B are another embodiments of the present invention similar in most of the components to FIG. 2, namely the anaerobic bioreactor 110, the densified aggregate selector 120 and the optional support media 104, with the difference of including an auxiliary bioreactor 130 which has the purpose of providing additional volume for biomass hold up and additional retention time for processing. The auxiliary bioreactor 130 is located in between the return line 124 of the granules separated in the densified aggregate selector 130 and the anaerobic bioreactor 110. In some embodiments a portion of the influent wastewater 106 is directed to the auxiliary bioreactor 130 and put in contact with the separated granules, while some embodiments do not direct influent flow to the auxiliary bioreactor 130. Yet in some embodiments an active exchange of mixed liquor 116, 136 (either flocs. granules or biofilm containing media or a combination) between the anaerobic bioreactor 110 and the auxiliary bioreactor 130 takes place. A portion of the mixed liquor 116 of the anaerobic bioreactor 110 is directed to the auxiliary bioreactor 130, set in contact with the returned granules and returned to the anaerobic bioreactor 110, and another mixed liquor 136 is directed from the auxiliary bioreactor 130 to the anaerobic bioreactor 130. The auxiliary bioreactor 130 in some embodiments is an anaerobic bioreactor 110 where additional biogas 132 is produced, yet in other embodiments the auxiliary bioreactor 130 is an aerobic bioreactor 110 where oxygen is provided to further aerobic decomposition. FIG. 3A further emphasizes an embodiment where the influent to the system is directed to the auxiliary bioreactor and contacted with the returned granules creating special conditions of high substrate concentration beneficial for larger aggregates.

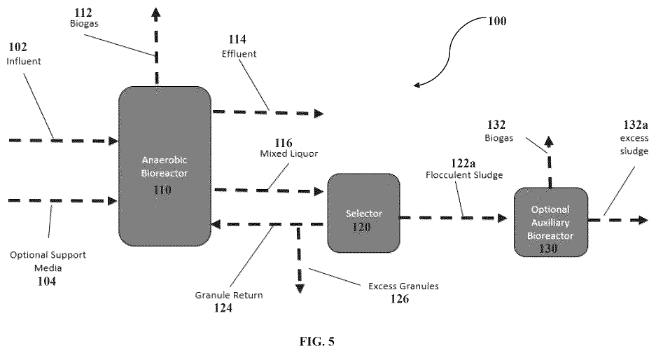

FIG. 4 is similar in its component to the previous figures an yet it illustrates another embodiment of the present invention where flocculent sludge 122a is selectively removed from the anaerobic bioreactor 110 by passing the mixed liquor 116 collected from the contents of the bioreactor 110 through the densified aggregate selector 130 and returning at least some of the granules to the bioreactor 110. The flocculent sludge 122a which passes through the densified aggregate selector 110 is either removed or sent to an optional auxiliary bioreactor 130 where further stabilization takes place; and once the flocculent sludge is stabilized is either wasted or returned to the bioreactor 110. Selectively removing flocculent sludge increases the fraction of active granular sludge in the bioreactor enhancing processing capacity. The anaerobic bioreactor 110 could be an acidogenic bioreactor and granules acidogenic granules. Air could be supplied to induce microaeration conditions in the anaerobic bioreactor 110 for hydrolysis enhancement. In some embodiments the anaerobic bioreactor 110 could be an anaerobic membrane bioreactor where a microfiltration of ultrafiltration membrane is part of the bioreactor. Selective removal of flocculent sludge in this embodiment will improve the solid liquid separation at the membrane increasing the flux rates through the membrane.

FIG. 5 is similar to FIG. 4 and illustrates yet another embodiment of the present invention where mixed liquor from the anaerobic bioreactor is collected and passed through a densified aggregate selector selectively removing flocculent sludge in one fraction and retaining and returning granules 124 to an auxiliary reactor 130 receiving influent wastewater 106 which is contacted in said auxiliary bioreactor 130 producing additional biogas. The auxiliary reactor 130 has an active mixed liquor exchange 136 with the main anaerobic bioreactor 110. Combination of selective removal of flocculent sludge and additional volume in the auxiliary bioreactor enhances the overall capacity of the anaerobic bioreactor. The anaerobic bioreactor could be an acidogenic bioreactor and granules acidogenic granules. Air could be supplied to induce microaeration conditions in the anaerobic bioreactor for hydrolysis enhancement. In some embodiments the anaerobic bioreactor could be an anaerobic membrane bioreactor where a microfiltration of ultrafiltration membrane is part of the bioreactor. Selective removal of flocculent sludge in this embodiment will improve the solid liquid separation at the membrane increasing the flux rates through the membrane.

Nutrient removal: This auxiliary bioreactor in any of the above figures could be supernated (for gravity or cyclonic approaches) or subnated (for floatation approaches) or solid-liquid separated in a manner to send a rbCOD or volatile fatty acid rich stream to a downstream reactor to support biological nutrient removal (for nitrogen or phosphorus removal). This way a decision (such as using a control and/or sensor if desired) can be made to manage carbon for gas production in the anaerobic environment or for its redirection to biological nutrient removal. The nitrogen removal could be conducted by heterotrophic or autotrophic organisms. The enhance biological phosphorus removal could be conducted by denitrifying or aerobic organisms. In one case, the carbon could be used to promote glycogen storage. This is an important disclosure given the desired carbon management needs that are beyond gasification at many locales. In some cases this carbon could be used to reduce nitrous oxide production from nitrogenous processes (from managing and improving low C/N ratios).

In one embodiment, the organisms (or their byproducts) supported in the auxiliary reactors have enhanced particle breakdown or hydrolysis characteristics. External enzymes or other bioagmentation materials could be added if desired to enhance reactions. If a pollutant has been sorbed or removed, the auxiliary bioreactor could be used for specialized treatment of such pollutant by any physical, chemical or biological means. While these additional embodiments are not disclosed in the figures, they are herein explicitly considered as part of the invention.

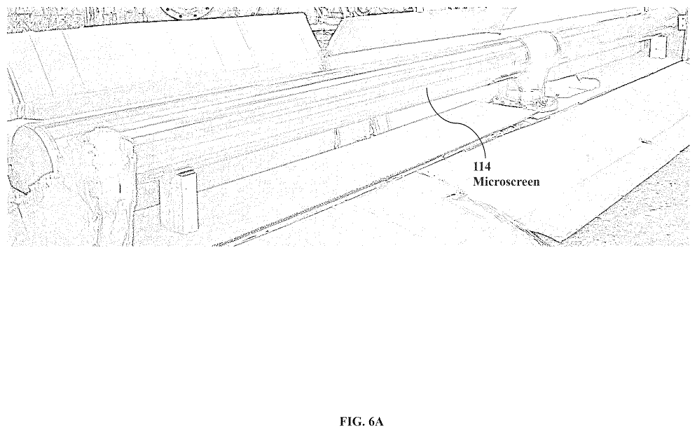

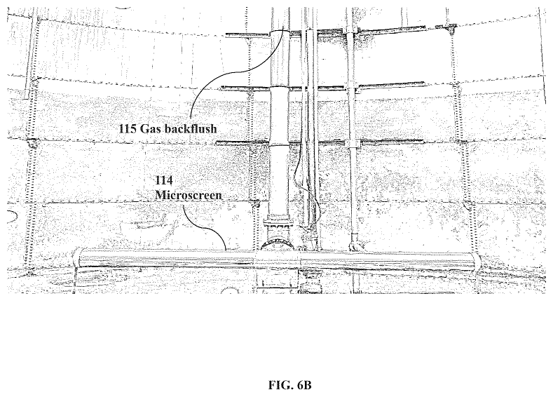

FIGS. 6A and 6B illustrate a reduction to practice of one microscreen (wherein microscreen is working as selector 120) of 150 micrometers, um, of effective sieve size according to the present invention. FIG. 6A illustrates the screen as delivered from manufacturing to the utility shop prior to installation. FIG. 6B illustrates the installation of said microscreen within a tank. Gas backflush 115 to the screen is also illustrated and runs internal to the liquid collection pipe to the microscreen.

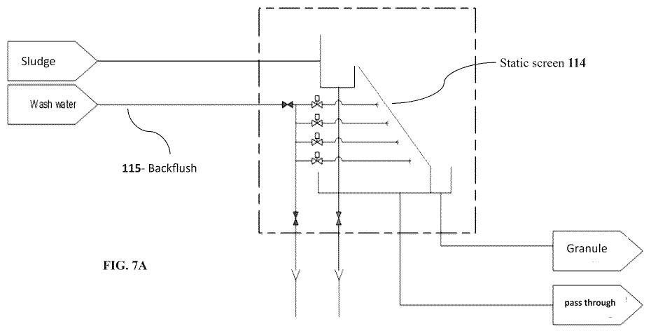

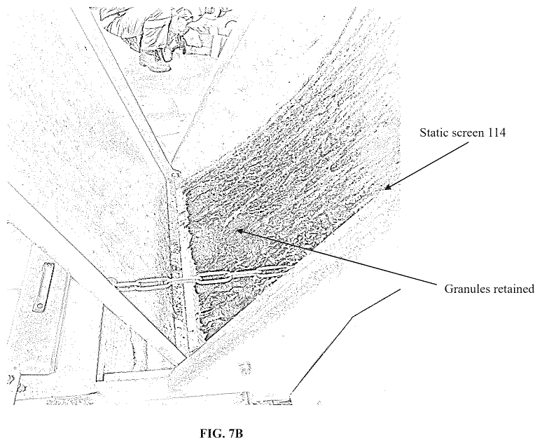

FIGS. 7A and 7B illustrate yet another reduction to practice of the present invention where a static screen is located externally to the anaerobic tank and influent sludge from the anaerobic tank is conveyed to the screen. FIG. 7A is a line diagram showing the conveyance of sludge to the screen, the water wash water lines to backflush 115 the screen and the two separated fractions, a pass-through fraction and a granule fraction. FIG. 7B shows a photograph of the installation of the static screen and illustrates the granules being retained by the screen.

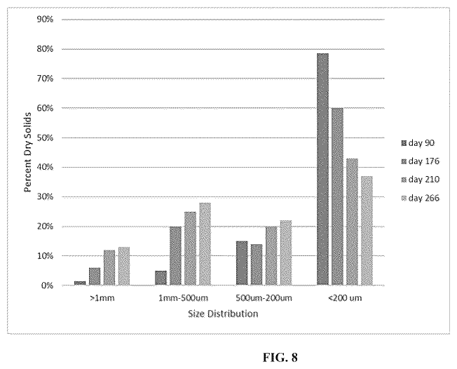

FIG. 8 illustrates the change in size distribution of the sludge particles, measured as percentage of dry solid matter, over time when a screen is applied to the waste sludge in a reactor according to this invention. Flocs pass through were wasted out of the reactor while granules were retained and returned. Screening was started in day 90. Four granule sizes are presented in the graph, larger than 1 mm, 500 um to 1 mm, 200 um to 500 um and less than 200 um, namely flocs. It is seen how the fraction of flocs, is reduced over time while the fraction of granules larger than 1 mm and granules in the 500 umm to 1 mm range increase in percentage.

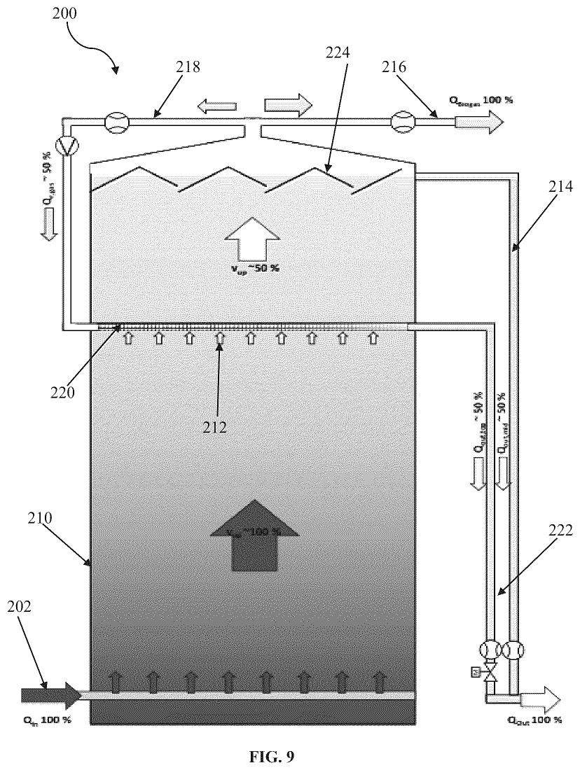

FIG. 9 is a schematic diagram of an enhanced wastewater treatment system 200 constructed in accordance with an embodiment of the present invention. In one embodiment an anaerobic bioreactor 210 receives influent 202 wastewater with carbonaceous, sulfurous or halogenated compounds or bubbled hydrogen gas, where at least a fraction is biogasified to form biogas 216, said biogas 216 is separated from the liquid effectively removing some of the carbonaceous, sulfurous or halogenated compounds or bubbled hydrogen gas from reacted mixture 212 wastewater (or augmented separately) and forming an effluent 214 wastewater. The influent 202 inlet is provided at the bottom of the anaerobic bioreactor 210 providing an upflow-velocity, Vup. The influent 202 is upflown to a densified aggregate selector 220 where a fraction of the granules is separated from the reacted mixture 212. The selector 220 is provided within the anaerobic bioreactor 210. The biogasification is carried out using densification by a mixture of flocculent sludge (lighter aggregates) and granules (or densified aggregates) provided with the influent 202 inside the bioreactor 210 and at least a fraction of said granules exits the selector 220 with the treated effluent through the exit line 222 In some embodiments the bioreactor 210 receives support media/granules (or uses inerts in the influent) to effectively enhance the formation of granules or otherwise support biofilms, while in other embodiments no support media is added, and the granules are formed with no apparent support (self-agglutinating). The reacted mixture 212 passes through the selector 220. The granules are separated from the reacted mixture 212 by the selector 220 to provide selector effluent 222 comprising fine particles and treated effluent. The mixture exits from the selector 220 via a first line 222. The biogas exits from the bioreactor 200 via second line 216. A gas recycle line 218 is also provided for intermittent flushing of the selector 220 using biogas. The gas recycle line 218 delivers a fraction of biogas to the selector 220 to be used as backwash gas. The treated reactor effluent exits from the reactor through the reactor effluent line 214. An exemplary distribution of flows, as others can be used, is shown for this embodiment in FIG. 9, 100% of the influent flow is distributed at the bottom of the reactor and approximately 50% of the flow is collected by the selector 220 diverting it away from the gas solid liquid separator structure 224 above. The upflow velocity Vup in the space above the selector 220 is only 50% of the upflow velocity below it. reducing the hydraulic load on the gas liquid separator 224 improving its performance. An exemplary flow of 50% of the biogas is illustrated in FIG. 9 for intermittent backflushing of the selector 220 but a range from 10% to 90% could be used depending on the needs for screen backflushing. Similarly, an exemplary range of 50% of the influent flow collected by the selector 220 is illustrated in FIG. 9 while the range could be from 10% to 90%.

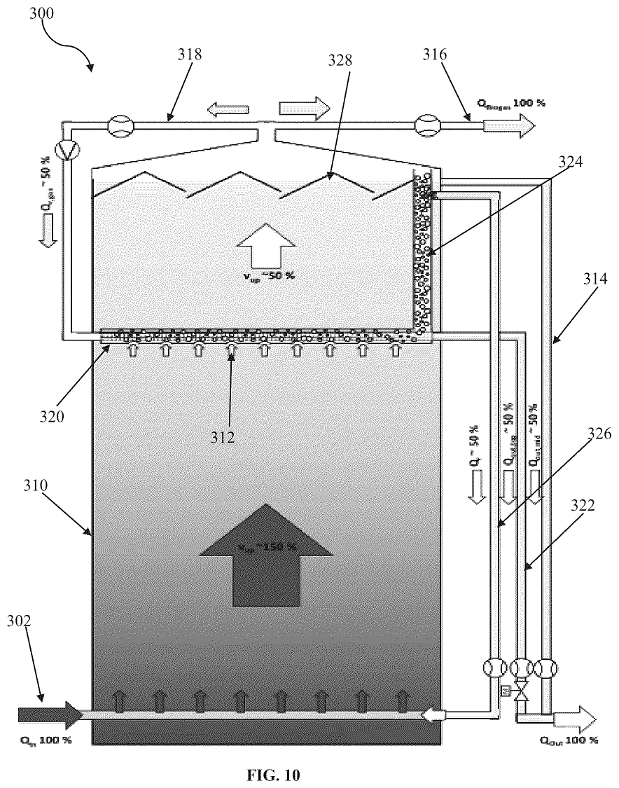

FIG. 10 is a schematic diagram of an enhanced wastewater treatment system 300 constructed in accordance with another embodiment of the present invention. In one embodiment an anaerobic bioreactor 310 receives influent 302 wastewater with carbonaceous, sulfurous or halogenated compounds or bubbled hydrogen gas, where at least a fraction is biogasified to form biogas 316, said biogas 316 is separated from the liquid effectively removing some of the carbonaceous, sulfurous or halogenated compounds or bubbled hydrogen gas from reacted mixture 312 wastewater (or augmented separately) and forming an effluent 314 wastewater. The influent 302 inlet is provided at the bottom of the anaerobic bioreactor 310 provide an upflow-velocity. The influent 302 is upflown to a densified aggregate selector 320 where a fraction of the granules is separated from the reacted mixture 312. The selector 320 is provided within the anaerobic bioreactor 310. The biogasification is carried out using densification by a mixture of flocculent sludge (lighter aggregates) and granules (or densified aggregates) provided with the influent 302 inside the bioreactor 310 and at least a fraction of said granules exits the selector 320 with the treated effluent through the exit line 322. In some embodiments the bioreactor 310 receives support media/granules (or uses inerts in the influent) to effectively enhance the formation of granules or otherwise support biofilms, while in other embodiments no support media is added, and the granules are formed with no apparent support (self-agglutinating). The reacted mixture 312 passes through the selector 320. The granules are separated from the reacted mixture 312 by the selector 320 to provide selector effluent comprising fine particles and treated effluent. The mixture exits from the selector 320 via a first line 322. The biogas exits from the bioreactor 300 via second line 316. A gas recycle line 318 is also provided. The gas recycle line 318 delivers a fraction of biogas to the selector 320 to be used as backwash gas. The treated reactor effluent exits from the reactor through the reactor effluent line 314. A granules collector 324 is coupled to the selector 320. The granules collector 324 is configured to collect the granules separated by the separator 320 from the reacted mixture 312. The separated granules are lifted by the flow of the back-wash-gas of the gas recycle line 318 and takes it to the granule collector 324. The separated granules are recycled by delivering them to the bottom of the anaerobic bioreactor 310 from the granules collector 324 via a granule recycle line 326. The same distribution structure used to spread the influent flow 302 in the bottom of the reactor can be used for the recycled flow 326. In some embodiments some of the flow in 326 can be directed to waste for selective fine particle removal as needed. An exemplary distribution of flows, as others can be used, is shown for this embodiment in FIG. 10, 100% of the influent flow is combined with 50% recycled flow collected at the selector level 320 and distributed at the bottom of the reactor forming a net upflow of 150% of the influent flow. This arrangement could be of use when light support media is used and increased upflow velocity is desired to keep them in suspension. Collection of approximately 50% of the flow by the selector 320 diverts away from the gas solid liquid separator structure 328 above. In an exemplary embodiment, the upflow velocity Vup in the space above the selector 320 is only 50% of the upflow velocity below it, reducing the hydraulic load on the gas liquid separator 224 improving its performance. An exemplary flow of 50% of the biogas is illustrated in FIG. 9 for intermittent backflushing of the selector 320 but a range from 10% to 90% could be used depending on the needs for screen backflushing. Similarly, an exemplary range of 50% of the influent flow collected by the selector 320 is illustrated in FIG. 10 while the range could be from 10% to 90%.

In some embodiments some of the granules separated from the reacted mixture 312 are wasted as excess granules and treated effluent exit through the line 322 while in other embodiments no wasting is conducted at this step. For the purpose of this invention a granule or densified aggregate or biofilm media selector 320 (collectively called densified aggregate selector densified aggregate selector 320) could be: a) a screen or any similar device (including but not limited to a filter mesh or fabric) where granules, self-agglutinating granules or support media induced granules, are retained by sieving the liquid and particles are separated based on factors such as size, compressibility, shape, magneticity or density. A multitude of different types of sieving equipment exists (including stationary, vibrating, rotating or moving) with associated wash equipment (air or fluid wash) in wastewater practice where granules can be separated from wastewater and that would be consider feasible for someone skilled in the art; b) a density-based or cyclonic (including but not limited to hydrocyclones, centrifuges, or a classifier) device, such as but not limited to a hydrocyclone, or a vortex separator where rotational flow is generated in the liquid in the device to induce a centrifugal force that is used to effectively separate the densified aggregates from the liquid based on granule characteristics such as size, shape and density.

Yet in some embodiments, the densified aggregate selector 320 is incorporated as one unit internal to the bioreactor 310. These screens (separating mainly based on particle size) or cyclonic separators could be individually used, be combined into a single unit, or be placed in series if so desired. Inerts could be removed (such as by sludge or wastewater degritting) before or after this granule/densified aggregate separation to have a holistic approach to managing and improving active inventories in the anaerobic bioreactor). Similarly, fats, oils and grease (FOG) or scum (including floatables) could be managed (such as through floatation or screening, especially if they are less dense or form globules) in this holistic inventory management approach within such separations, either in series or parallel to the densified aggregate selector. In one example embodiment, large floatables are removed (and wasted) before smaller granules are retained. Any parallel, series, tributary or distributary approach is possible for such solids management.

Aspects and embodiments disclosed herein are not limited in application to the details of construction and the arrangement of components set forth in the following description or illustrated in the drawings. Aspects and embodiments disclosed herein are capable of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

Having thus described several aspects of at least one embodiment of this invention, it is to be appreciated that various alterations, modifications, and improvements will readily occur to those skilled in the art. Such alterations, modifications, and improvements are intended to be part of this disclosure and are intended to be within the spirit and scope of the invention. Accordingly, the foregoing description and drawings are by way of example only.

What is claimed is:

1. A method for enhancing treatment or capacity or purifying gas of an anaerobic process used for wastewater treatment by:
a. sending an influent to anaerobic process
b. performing treatment in said anaerobic process
c. collecting or evacuating gas from said anaerobic process
d. collecting one or more of a portion of contents from the anaerobic process or an effluent from said anaerobic process,
e. passing one or more portions of contents from the anaerobic process or said effluent through a densified aggregate selector to form a fraction containing granules and one or more of flocculant sludge or a treated effluent for discharge and,
f. returning or retaining at least a portion of the fraction containing one or more granules to the anaerobic process,
g. optionally adding support media to the anaerobic process.

2. The method of claim 1, wherein at least a portion of fraction containing one or more granules is first returned to an auxiliary bioreactor prior to returning to the anaerobic process.

3. The method of claim 2, wherein the auxiliary bioreactor has a mixed liquor exchange with the anaerobic process, or wherein the auxiliary bioreactor is operated under anaerobic conditions producing a stream of biogas or wherein a stream of oxygen may be supplied to the auxiliary bioreactor via influent stream or, wherein the auxiliary bioreactor receives at least a portion of the influent flow or sends at least a portion of effluent flow of the auxiliary bioreactor to biological nutrient removal, or wherein the auxiliary bioreactor receives at least a portion of the influent flow.

4. The method of claim 1, wherein the optional support media is a reactive media.

5. The method of claim 1, wherein hydrogen gas is supplied to the anaerobic process for methane production

6. The method of claim 1 wherein the selector is one or more of a screen, one or more of a hydrocyclone, or one or more or a dissolved air floatation device that are either internal to the anaerobic process or external to the anaerobic process

7. The method of claim 1, wherein the anaerobic process is any tank or tanks or pipe or pipes or zone or zones of any shape including a sewer, a primary tank or clarifier, a gravity thickener, a membrane bioreactor, a upward anaerobic sludge blanket reactor, or any container intended for anaerobic treatment.

8. The method of claim 1, wherein the anaerobic bioreactor is an acidogenic or an acetogenic bioreactor.

9. The method of claim 1, wherein the oxygen is introduced to the acidogenic bioreactor to enhance hydrolysis reactions or to produce elemental sulfur or to remove hydrogen sulfide from the biogas.

10. The method of claim 2, wherein hydrogen gas is added to the auxiliary bioreactor to further methane production and methane enrichment in biogas.

11. A system for enhancing the treatment or capacity or purifying gas of an anaerobic bioreactor used for wastewater treatment comprising: an influent source to the bioreactor, an optional source of support media, an anaerobic bioreactor, a densified aggregate selector, an optional auxiliary bioreactor, an optional source of oxygen, and pipes, valves, and pumps to fluidly connect the above-mentioned parts of the system and the system is arranged in ways that:
a. the influent source to the bioreactor is fluidly connected to said anaerobic bioreactor,
b. the bioreactor has means of optionally receiving support media from the source,
c. said bioreactor is fluidly connected to the inlet of the densified aggregate selector, and one of the outlets of the densified aggregate selector is fluidly connected to the anaerobic bioreactor and wherein the densified aggregate selector can be internal or external to the anaerobic bioreactor
d. the bioreactor has an outlet for evacuating gas

12. The system of claim 11, wherein an auxiliary bioreactor is fluidly connected to the outlet of the densified aggregate selector containing the separated granules, and fluidly connected to the anaerobic bioreactor, and has an optional fluid connection to the influent flow, and an optional connection to a nutrient removal bioreactor, or wherein the anaerobic bioreactor and the auxiliary bioreactor fluid connections are configured to allow a mixed liquor or granule or densified biomass exchange between the two bioreactors.

13. The system of claims 11, wherein means of supplying a stream of oxygen to the auxiliary or to the anaerobic bioreactor are provided.

14. The system of claims 11, wherein the anaerobic bioreactor is any tank or tanks or pipe or pipes or zone or zones of any shape including a sewer, a primary tank or clarifier, a gravity thickener, a membrane bioreactor, a upward anaerobic sludge blanket reactor, or any container intended for anaerobic treatment.

15. The system of claims 11, wherein the support media is reactive media.

16. The system of claim 11, wherein hydrogen gas is supplied to the anaerobic process for methane production

17. The system of claim 11, wherein the selector is one or more of a screen, one or more of a hydrocyclone, or one or more or a dissolved air floatation device that are either internal to the anaerobic process or external to the anaerobic process

18. The system of claim 11, wherein the size of the granule or densified aggregate ranges between 100 microns and 5,000 microns, or between 50 microns and 10,000 microns.

19. A system for enhancing the treatment or capacity or purifying gas of an anaerobic bioreactor used for wastewater treatment comprising:
an anaerobic bioreactor to form a reaction mixture of granules and treated effluent from the wastewater;
an influent fluidically coupled to bottom of the anaerobic bioreactor to provide wastewater with upflow velocity;
a selector installed in medial region of the anaerobic bioreactor, wherein the anaerobic bioreactor is configured to separate the granules from the reacted mixture of the anaerobic bioreactor, and a fraction of the separated granules is recycled back to the anaerobic bioreactor; and
a gas recycle line fluidically couples a fraction of biogas released from the reactor to the selector for backflushing.

20. A system for enhancing the treatment or capacity or purifying gas of an anaerobic bioreactor used for wastewater treatment comprising:
an anaerobic bioreactor to form a reaction mixture of granules and treated effluent from the wastewater;
an influent fluidically coupled to bottom of the anaerobic bioreactor to provide wastewater with upflow velocity;
a selector installed in medial region of the anaerobic bioreactor, wherein the anaerobic bioreactor is configured to separate the granules from the reacted mixture of the anaerobic bioreactor;
a granule collector communicably coupled to a selector to collect the separated granules;
a gas recycle line fluidically couples a fraction of biogas released from the reactor to the selector for backflushing, wherein the gas recycle line is configured to provide backwash gas required to deliver granules from the selector to the granules collector; and
a granule recycle line coupling the granule collector to the bottom of the anaerobic reactor to recycle a fraction of granules back into the anaerobic reactor for wastewater treatment.

21. A system of claim 19, wherein the upflow velocity in the space above the selector is only approximately 50% of the upflow velocity below it, or between 10% to 90% said upflow velocity below it, or wherein a biogas flow of approximately 50% of biogas produced is used for intermittent backflushing, or between 10% to 90% of said biogas produced.
